(19) United States
(12) Patent Application Publication
(10) Pub. No.: US 2007/0249811 A1
(43) Pub. Date: Oct. 25, 2007

(54) Method for Producing and Purifying Gelatin

(76) Inventors: Kerstin Christensson, Landskrona (SE); Stefan Levin, Angelholm (SE); Markus Jansson, Helsingborg (SE); Markkus Andreasson, Helsingborg (SE)

Correspondence Address: BUCHANAN, INGERSOLL & ROONEY PC, POST OFFICE BOX 1404, ALEXANDRIA, VA, 22313-1404, US

(21) Appl. No.: 11/629,409

(22) PCT Filed: Jan. 21, 2005
(86) PCT No.: PCT/SE05/00059

§ 371 Date: Jan. 24, 2007

(30) Foreign Application Priority Data
Jul. 2, 2004 (SE) 0401779-4

(51) Int. Cl. C09H 3/02

(52) U.S. Cl. 530/355

(57) ABSTRACT

This invention relates to a method for purifying a gelatin solution obtained in a continuous process from raw material consisting of fresh defatted bone material from pig, cattle, sheep or chicken, which method comprises the steps of grinding the raw material, optionally with addition of water, mixing the ground raw material with more water to form a slurry, subjecting the slurry, in optional order, to an adjustment of the pH to 2.4-3.9 and to an adjustment of the temperature to 90-125° C. and maintaining these conditions for a time of 90 s to 1020 s. The slurry is then separated into a liquid phase and a solid phase, the pH is adjusted to 6.0-7.0, floccules formed are separated and the solution is clarified by filtration. This invention further relates to a gelatin obtained according to this method.

### FIELD OF THE INVENTION

This invention relates to a method for purifying a gelatin solution obtained in a continuous process from raw material consisting of fresh defatted bone material from, for example, pig, cattle, sheep or chicken, which method comprises the steps of grinding the raw material, optionally with an addition of water, mixing the ground raw material with more water to form a slurry, subjecting the slurry, in optional order, to an adjustment of the pH to 2.4-3.9 and to an adjustment of the temperature to 90-125° C. and maintaining these conditions for a time of from 90 s to 1020 s.

This invention further relates to a gelatin produced according to said method.

### BACKGROUND ART

Gelatin is a natural product that is used extensively in the food industry, but also in the pharmaceutical, the photographic, the textile and the paper industry. Gelatin, which is a protein, is obtained from collagen that occurs in the skin, connective tissue, bones and other parts of animals, mammals as well as birds and fish.

The methods for producing gelatin differ considerably depending on the raw material employed. When the raw material is bone, for example, prior-art techniques require time-consuming processes to provide a clear, high-quality gelatin. Whole bones or bones divided into pieces are first defatted, dried and sorted and then demineralised completely with acid at a low temperature and for several days, so that the collagen matrix is exposed and ossein is obtained. The purpose of such demineralisation is to dissolve the calcium salts in the bone, thereby to expose the collagen matrix. The demineralisation step is very important for obtaining a clear, high-quality gelatin. After demineralisation, the ossein is “conditioned” by means of alkali for 1-6 months at a low temperature. In this treatment, the intermolecular bonds are broken up, the solution is neutralised and the collagen is extracted at an elevated temperature. The collagen is denatured, and gelatin is obtained.

Alternatively, “conditioning” may imply acid treatment, which means that acid is used in the place of alkali, thus reducing the conditioning time to about 1-4 days.

Depending on the field of application, different quality requirements are placed on the gelatin. Gel strength, for instance, is an important property of gelatin. Conventionally, gel strength is indicated in Bloom numbers. Thus, a Bloom number of >about 240 indicates high-quality gelatin, a Bloom number of about 120-240 indicates average-quality gelatin, and a Bloom number of <about 120 indicates low-quality gelatin.

Furthermore, gelatin clarity is of great importance. Turbidity can be analysed using different methods of analysis, such as NTU measurement (Nephelometric Turbidity Units). At a solution dry content (TS content) of 6.67%, a measurement of 50-30 NTU indicates a clear gelatin and <30 NTU indicates a very clear gelatin. At a pH variation of 3-6, turbidity should not vary either in a finished gelatin solution with a TS content of 6.67%.

EP-A1-0 689 570 describes a method for producing gelatin from a collagen-containing raw material, comprising the steps of

a) grinding the raw material to a particle size not exceeding 1 mm,

b) mixing the ground raw material with water to form a slurry,

c) subjecting the slurry from step b), in optional order, to an adjustment of the pH to 2-5 and to an adjustment of the temperature to 60-130° C. for a time of 1 s to 1 h,

d) lowering the temperature of the slurry to complete the reaction,

e) separating the slurry into a gelatin-containing liquid portion and a solid residue,

f) increasing the pH of the slurry or the liquid portion before or after, respectively, the separation, and

g) recovering the gelatin from the liquid portion in filtering steps and/or other purification steps, with essentially no removal of process water in steps a)-f).

However, the quality and clarity of the gelatin solution obtained according to the method described in EP-A1-0 689 570 are such that additional purification steps are required. In addition to minerals, there are fat and undesirable proteins which must be removed.

EP 0 323 790 discloses a method for producing gelatin in which clarifying is carried out by adding specific flocculants, such as ammonium phosphate and aluminium phosphate. However, the effectiveness as to the resulting clarification is not indicated. Moreover, the raw material used is dry bone powder which is demineralised in the method, before gelatin extraction occurs, which implies long process times and the use of a large number of chemicals as well as large quantities of water.

Accordingly, there is a need to provide a clear, high-quality gelatin from raw material consisting of fresh bones, the method of production allowing, in addition, shorter process times, fewer process steps and chemicals, which means less impact on the environment.

### SUMMARY OF THE INVENTION

The object of the present invention is to provide a method for purifying (e.g. lowering the fat content and the content of undesirable proteins, i.e. non-collagen proteins) and clarifying gelatin, in which the above problems and drawbacks have been eliminated or alleviated.

According to the invention, this object is achieved by a method for purifying a gelatin solution obtained in a continuous process from raw material consisting of fresh defatted bone material from pig, cattle, sheep or chicken, which method comprises the steps of

a) grinding the raw material, optionally with addition of water,

b) mixing the ground raw material with more water to form a slurry,

c) subjecting the slurry from step b), in optional order, to an adjustment of the pH to 2.4-3.9 and to an adjustment of the temperature to 90-125° C. and maintaining these conditions for a time of 90 s to 1020 s,

d) subsequently separating the slurry into a liquid phase and a solid phase, preferably in a decanter centrifuge,

e) subsequently optionally subjecting the solid phase once more to steps b) to d), after which the liquid phases are combined,

f) adjusting the pH to 6.0-7.0,

g) gently separating formed floccules from the gelatin solution, preferably in a separator, and

h) clarifying the solution by filtration through a filter, preferably a pressure filter.

According to a preferred embodiment, the inventive method further comprises, in optional order between steps g) and h), the steps of

i) quick-cooling the solution to a temperature of 50-70° C., preferably 55° C., and

j) adding acid to a pH of 4.5-5.0.

According to another preferred embodiment of the invention, the method further comprises the steps of

k) concentrating and desalting the solution, preferably with an ultrafilter,

l) filtering the concentrated solution through a polishing filter, preferably a sheet filter, and

m) concentrating, sterilising and drying the solution according to conventional techniques to a commercially dry gelatin.

According to yet another preferred embodiment, floccules are gently separated in step g) in a continuous high-speed separator. In a still further embodiment, the separator is a two-phase separator and in yet another one also hermetic (high speed clarifier with variable discharge system (OWMC) and with hermetic design).

According to a further embodiment, the filter in step h) is a pressure filter using a filter aid containing, inter alia, kieselguhr.

According to another preferred embodiment the pH is adjusted in step f) to 6.5, preferably by NaOH.

According to yet another preferred embodiment, the acid is added in step i) to pH 4.9, preferably by means of H₃PO₄.

Owing to the method according to the present invention a clear gelatin solution is obtained, having a high Bloom number and a low fat content. By gently feeding the solution to the separator the fragile floccules formed in connection with the increase in pH are not fragmented but can be separated from the solution. Another major advantage is that fat will come away with the heavy phase and, thus, will not remain in the gelatin solution.

### BRIEF DESCRIPTION OF THE DRAWING

The invention will now be illustrated in more detail, reference being made to the appended drawing, on which

FIG. 1 is a flowchart illustrating the process according to the invention.

### DETAILED DESCRIPTION OF AN EMBODIMENT OF THE INVENTION

According to the invention, the raw material employed consists of cut bones from cattle, pig, sheep and chicken obtained from meat-cutting centres or the like. The bones are food graded and meet the requirements of the National Swedish Food Administration FS 1994:10 “Allmänna r\dot{a}d om köttbiprodukter mm.” and Directive 92/5/EEC. Bone from respectively cattle, sheep and pig are used separately or mixed. The term pig bone also covers pigs' trotters and pigs' sculls.

The bones can be fresh cooled as well as frozen. The raw material is emptied into a bin and is transported by means of one or more feed screws to a conveyor belt, where plastic and other non-desirable objects are removed. The raw material also passes a metal detector to prevent metal from entering the process. The conveyor belt feeds the raw material to a mill in which the raw material is ground to a particle size of <28 mm. The ground raw material is advanced through the process in a transport screw, fed through a melt pipe, in which rendering of the fat occurs by means of heated vapour directly in the raw material. The melt pipes are equipped with a variable gear motor, which means that the heating time can be varied. The temperature is controlled automatically on the basis of a set reference value and is about 70-95° C. in the output material. After the rendering of the fat, the substance is pumped to a decanter centrifuge where the material is separated into a solid phase and a liquid phase. Decanting occurs at about 70-90° C. and the solid phase obtained should have a dry fat content not exceeding 6%.

The rendering process is gentle and the duration of this process step, from bone to defatted bone, is estimated at about 5 minutes.

The solid phase, the gelatin raw material, is transported instantaneously, without any further processing, to the gelatin process. The solid phase, defatted bones, has a typical composition as shown in Table 1.

TABLE 1
Typical composition in defatted pig bone
and cattle bone, respectively, i.e. gelatin raw material

| | | | | Ash | Bone | Gelatin |
|---|---|---|---|---|---|---|
| | Water | Protein | Fat | content | content | substance |
| | content % | content % | content % | % | % | % |
| Pig | 46 | 27 | 2-4 | 24 | 65 | 11-16 |
| Cattle | 40 | 28 | 2 | 30 | 75 | 16-20 |

The defatted bone substance, which has a temperature of about 70-90° C., is transported by means of a transport screw via a belt weigher 1 to one or more mills 2 for further grinding with or without addition of water. Two mills in series are used to grind the bone substance with addition of water to a particle size of <1 mm, preferably <0.2 mm. The finely ground bone-water slurry is transferred directly to a tank 3 where more water is added to a slurry TS content of 5-20%.

The slurry is pumped continuously from the tank 3 to a reactor 5 in the form of a pipe system at a speed of preferably 2 m/s, but not less than 1 m/s, to prevent settling and to achieve a turbulent flow. The slurry is heated rapidly by direct addition of vapour or by means of an appropriate heat exchanger 4 (e.g. a scraped heat exchanger) to 95-125° C., after which acid, suitably concentrated (75%) food-quality phosphoric acid, is added to the hot slurry to a pH of 2.4-3.9, measured about 3 minutes after the addition of acid. It is important that the acid is mixed in quickly and uniformly to avoid extremely low pH values in the slurry. The hot and acid slurry is then pumped to a pipe system at a speed of at least 1 m/s, preferably 2 m/s, during 90-1020 s (1.5-17 min).

Preferably, the pipe system is made of an electropolished stainless material to prevent the deposition of above all Ca-salts on the surface and is insulated so that the solution maintains the desired temperature during the whole extraction time. Maintaining accurate parameters during extraction requires continuous measuring of volume and mass flow, temperature and pH by means of on-line instruments. The pipe system extraction time is estimated based on the pipe volume and the flow through the pipes. Since gas (carbon dioxide) is formed when adding an acid, a pressure above atmospheric needs to be maintained in the system. The overpressure is also necessary to prevent the solution from boiling at temperatures >100° C.

When the slurry is kept at a high temperature, a low pH and is being stirred, the collagen is converted to gelatin. The process conditions (low pH, high temperature) causes the proteins to be broken down into smaller components, which means that temperature, pH and residence time are selected depending on the desired gelatin quality and the desired yield. When the desired extraction time has been reached, the pressure is equalized to atmospheric pressure and the slurry is then pumped to a decanter centrifuge 6 to be separated into a solid phase and a gelatin solution. The solid phase can be mixed with water once more and processed one more time in the same way as before, i.e. heating, addition of acid, extraction time and separation with a decanter centrifuge into a solid phase and a gelatin solution. For the second extraction, different process parameters can be selected, if desired, within the specified intervals.

The two gelatin solutions, which have a pH of about 2.4-3.9 and a temperature of about 85-98° C., are mixed in a tank 7 and gently transferred by pumping, preferably by means of a displacement pump. After the pump, a base, preferably concentrated (food-quality) NaOH, is added to a pH of 6.0-7.0, preferably 6.5. Fragile floccules consisting of Ca-salts, fat and proteins are formed at this stage. The floccules are separated very gently in a hermetic separator 8, preferably a two-phase separator, for example an Alfa Laval BRPX714 HGV-34C. If the floccules are subjected to large shear forces and destroyed, a stable suspension is formed that is virtually impossible to separate, the end result being the formation of a turbid gelatin solution. The amount of caustic solution added is chosen so that the solution, if extracted in a beaker, can spontaneously form two distinct phases, a clear gelatin supernatant and a subnatant consisting of calcium salts, fat and proteins.

The gelatin solution obtained after the separator 8, which solution is fat-free (i.e. <0.05 %) and has an NTU value of <100, is cooled in a cooling device 9, preferably a (plate) heat exchanger, to about 50-70° C., preferably about 55° C., to reduce any further deterioration of the quality of the gelatin solution and is transferred by pumping via a tank 10. Acid is then added, for example concentrated phosphoric acid, to a pH of 4.5-5.0, preferably 4.9. Again, it is important to mix the acid carefully with the solution, either at a turbulent flow or by means of a static mixer, or a combination thereof. The tank 10 is used to achieve an even flow regardless of blasts from the separator. The acid is added to precipitate proteins causing turbidity in the end product, i.e. the gelatin. The precipitated proteins are filtered out in a pressure filter 11 using a filter aid containing, inter alia, kieselguhr. The solution is now ready, having an NTU <10, preferably NTU <5 measured in a solution with a TS content of about 1.5%.

It is necessary to adjust the pH of the gelatin solution to obtain a gelatin that is stable in terms of turbidity when the finished gelatin is used in an acid environment, pH 3-6.

The clear solution is concentrated in a filter 12, preferably an ultrafilter (UF) with a cut off, for example, of 5000 Dalton. During the concentration purified water is added, preferably RO permeate (RO=Reverse Osmosis) from a filter 13, which is then evaporated as a permeate and, thus, the salts are washed out. When using RO permeate, the water is recycled in an environmentally-friendly manner. In this way, the ash content can be reduced to the desired level. The ash content of the end product is controlled by the amount of water added, preferably RO permeate. Finally, the solution is pumped through a so-called sheet filter 14 for extra clarification before the solution undergoes the final processing (concentration, sterilisation, cooling and drying).

After the sheet filter 14, the gelatin solution can have a dry content of up to 25% and a fat content corresponding to <0.02 % in commercially dry gelatin. The turbidity in the form of NTU (TS content of 6.67 %) can be NTU <30, preferably NTU <15. The gelatin has an acceptable smell and taste and the desired pH is about 4.5-5.5. The pH increases during desalting in the ultrafilter. Quality parameters in the form of gel strength (Bloom number) and viscosity are controlled through the parameters of the extraction process, as is the yield.

The method according to the invention reduces the process time from fresh bone to dry gelatin from several months to <12 h. Among other things, this is due to the fact that drying, sorting and demineralisation of the raw material are not required. A high-clarity gelatin is obtained nonetheless.

The invention will now be described in more detail by means of examples, none of which are to be interpreted in a way that limits the invention.

### EXAMPLES

Experiments 1-3

In these experiments, defatted pig bone was ground using two mills connected in series and with addition of water. More water was added, the slurry was heated by means of a scraped heat exchanger, concentrated phosphoric acid was added to a desired pH measured about 3 min after the addition of acid. The hot, acid slurry was pumped under pressure through a pipe system at speed of at least 1 m/s for the desired time. The pipe system was designed in such manner that the residence time could be controlled, and the pH could be documented at the desired moment after addition. The pipe system was insulated to minimize heat loss. When the desired reaction time was reached, the pressure was released to atmospheric and the slurry decanted, using a so-called decanter, into two phases, a solution and a solid phase. The solid phase was processed one more time by the addition of water, heating, addition of acid and pumping through a pipe system in the same manner as that described above. The slurry was decanted and a second solution obtained. The two solutions were mixed and transferred by pumping at a flow rate of 3000 l/h. After the pump, in this case a displacement pump (Johnson Pump Top Wing Lobrotorpump TW 2), concentrated sodium hydroxide was added and the solution separated in a continuous hermetic two-phase high-speed separator having a disc stack with 0.4 mm spacing and with a slit (Alfa Laval High Speed Separator Type BRPX 714 HGV −34C Disc stack with 0.4 mm caulks and slits in disc) and a blast time interval of 3 min. The solution was pumped from the separator, quick-cooled in a plate heat exchanger, and then pumped continuously via a tank to the pressure filter. Between the tank and the pressure filter, concentrated phosphoric acid was added in-line. The acidified solution was filtered through a pressure filter coated with kieselguhr before it was concentrated and desalted in an ultrafilter with a cut off of 5000 Dalton. The solution was pumped through a sheet filter, after which samples were taken and analysed with respect to, for instance, clarity.

All the relevant process variables are accounted for in Tables 2 and 3 below. The results indicated a stable gelatin solution having acceptable clarity at all the desired pH levels (see Table 5). For end product quality, see Table 4.

### Comparative Example 1

The same method as that of experiments 1-3 described above was used, but with only a small addition of phosphoric acid after the separator. The gelatin solution obtained had acceptable clarity (see Table 5), but the clarity is not as stable as in experiments 1-3 described above.

All the relevant process variables are accounted for in Tables 2 and 3 below. For end product quality, see Table 4.

### Comparative Example 2

The same method as that of experiments 1-3 described above was used, but no phosphoric acid was added after the separator. The gelatin solution obtained had acceptable clarity (see Table 5), but the clarity is not as stable as in experiments 1-3 described above.

All the relevant process variables are accounted for in Table 2 below. For end product quality, see Table 4.

TABLE 2
Various process parameters

| | | | | | Comp | Comp |
|---|---|---|---|---|---|---|
| | Unit | Exper 1 | Exper 2 | Exper 3 | ex 1 | ex 2 |
| Particle size* | Mm | <0.3 | <0.5 | <0.5 | <0.5 | <0.5 |
| Extr 1 | % | 6.7 | 6.8 | 6.8 | 6.6 | 6.4 |
| Slurry TS cont | | | | | | |
| Temp | ° C. | 115 | 105 | 105 | 105 | 105 |
| pH | | 3.0 | 3.2 | 3.2 | 3.2 | 3.2 |
| Time | S | 300 | 300 | 300 | 300 | 300 |
| Extr 2 | % | 4.5 | 4.6 | 4.6 | 4.5 | 5.1 |
| Slurry TS cont | | | | | | |
| Temp ° C. | ° C. | 115 | 105 | 105 | 105 | 105 |
| pH | | 3.0 | 3.2 | 3.2 | 3.4 | 3.2 |
| Time | s | 345 | 336 | 335 | 338 | 337 |
| pH base, | | 6.5 | 6.5 | 6.6 | 6.5 | 6.5 |
| Test point B | | | | | | |
| Temp, | ° C. | 56 | 54 | 56 | 59 | 58 |
| Test point C | | | | | | |
| pH acid, | | 4.6 | 4.7 | 4.2 | 5.3 | 6.6 |
| Test point C | | | | | | |
| pH product, | | 5.1 | 5.2 | 4.9 | 5.5 | 6.8 |
| Test point E | | | | | | |

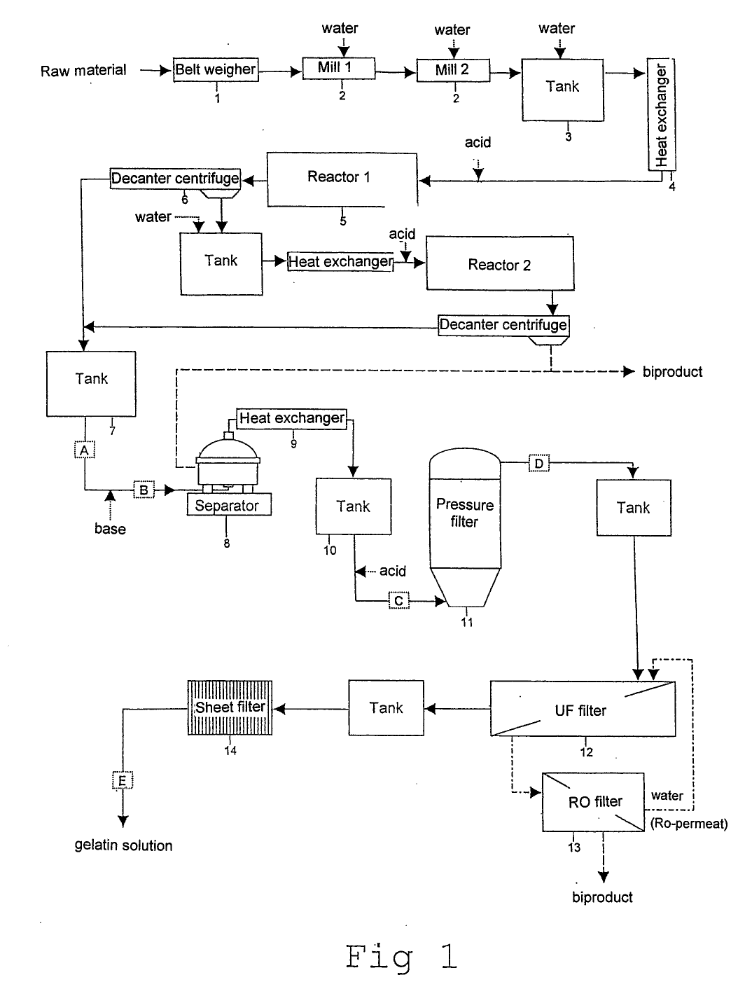

*The particle size is measured with a Mastersizer instrument. Test points are indicated in FIG. 1.

TABLE 3
Analysis of the solution during production

| | | | | Comp | Comp |
|---|---|---|---|---|---|
| | Exper 1 | Exper 2 | Exper 3 | ex 1 | ex 2 |
| Test point A | 2.3 | — | 2.6 | 2.2 | 1.8 |
| TS % | | | | | |
| % Protein | 1.3 | — | 1.4 | 1.0 | 0.90 |
| % Fat | 0.10 | 0.18 | 0.10 | 0.11 | 0.16 |
| Test point D | 1.9 | — | 1.9 | 1.7 | 1.3 |
| % TS | | | | | |
| % Protein | 0.60 | — | 1.0 | 0.8 | 0.8 |
| % Fat | <0.005 | 0.03 | 0.01 | <0.005 | 0.03 |
| Protein | 54 | — | 29 | 20 | 11 |
| loss, % | | | | | |
| Fat loss, % | >95 | — | 90 | >95 | 81 |

Test points are indicated in FIG. 1.

TABLE 4
Quality of end product

| | | | | | Comp | Comp |
|---|---|---|---|---|---|---|
| | Unit | Exper 1 | Exper 2 | Exper 3 | ex 1 | ex 2 |
| Turbidity | NTU | 4 | 6 | 8 | 15 | 17 |
| (6.67%) | | | | | | |
| Bloom (6.67%) | g | 205 | 260 | 260 | 285 | 180 |
| Fat content | % | <0.005 | — | — | — | — |
| Isoelectric | | 8.1 | 8.1 | 8.2 | 7.7 | 7.0 |
| point (IEP) | | | | | | |
| (5%) | | | | | | |
| Viscosity | mP | 22 | 31 | 31 | 31 | 22 |
| (6.67%) | | | | | | |
| Yield* | % | 13.6 | — | 10.1 | 9.4 | — |

*g dry gelatin (90%) of 100 g defatted bone.

TABLE 5
Result: Stability with respect to clarity at
different pH levels

| | | |
|---|---|---|
| Exper 1 | Exper 2 | Exper 3 |

| pH | NTU | pH | NTU | pH | NTU |
|---|---|---|---|---|---|
| 4.9 | 5 | 5.3 | 14 | 4.7 | 12 |
| 4.1 | 8 | 4.8 | 9 | 4.2 | 11 |
| 3.5 | 8 | 4.3 | 9 | 3.5 | 10 |
| 2.6 | 4 | 3.8 | 9 | 2.3 | 9 |

| | |
|---|---|
| Comp ex 1 | Comp ex 2 |

| pH | NTU | pH | NTU |
|---|---|---|---|
| 5.4 | 22 | 6.8 | 17 |
| 5.0 | 60 | 6.5 | 30 |
| 4.5 | 250 | 6.0 | 190 |
| 4.0 | 365 | 5.0 | 520 |
| 2.9 | 218 | | |

NTU is measured at a TS content of 6.67 in gelatin solution.

The examples show that when, after the separator, a small amount of acid is added, see comparative Example 1, or none at all, see comparative Example 2, a gelatin with an NTU value of respectively 22 and 17 is obtained, which, in fact, is fairly good. In acid environments, however, these gelatins do not have a stable clarity, which results in considerable turbidity in the form of extremely high NTU values. In contrast, in Examples 1-3 according to the invention the NTU values are extremely low also under acid conditions.

1. A method for purifying a gelatin solution obtained in a continuous process from a raw material consisting of fresh defatted bone material from pig, cattle, sheep or chicken, which method comprises the steps of
a) grinding the raw material, optionally with addition of water,
b) mixing the ground raw material with more water to form a slurry,
c) subjecting the slurry from step b), in optional order, to an adjustment of the pH to 2.4-3.9 and to an adjustment of the temperature to 90-125° C. and maintaining these conditions for a time of 90 s to 1020 s, characterised by
d) subsequently separating the slurry into a liquid phase and a solid phase, preferably in a decanter centrifuge,
e) optionally subjecting the solid phase, subsequently, once more to steps b) to d), after which the liquid phases are combined,
f) adjusting the pH to 6.0-7.0,
g) gently separating formed floccules from the gelatin solution, preferably in a separator, and
h) clarifying the solution by filtration trough a filter, preferably a pressure filter.

2. A method as set forth in claim 1, further comprising, in optional order between steps g) and h), the steps of
i) quick-cooling the solution to a temperature of 50-70° C., preferably 55° C., and
j) adding acid to a pH of 4.5-5.0.

3. A method as set forth in claim 1, wherein floccules are gently separated in step g) in a continuous high-speed separator.

4. A method as set forth in claim 1, wherein floccules are gently separated in step g) in a two-phase separator.

5. A method as set forth in claim 1, wherein floccules are gently separated in step g) in a hermetic separator.

6. A method as set forth in claim 1, wherein the filter in step h) is a pressure filter using a filter aid containing, inter alia, kieselguhr.

7. A method as set forth in claim 1, further comprising the steps of
k) concentrating and desalting the solution, preferably with an ultrafilter,
l) filtering the concentrated solution through a polishing filter, preferably a sheet filter, and
m) concentrating, sterilising and drying the solution according to conventional techniques to a commercially dry gelatin.

8. A method as set forth in claim 1, wherein in step f) the pH is adjusted to 6.5.

9. A method of set forth in claim 1, wherein in step j) the acid is added to a pH of 4.9.

10. A method as set forth in claim 1, wherein the pH in step f) is adjusted by NaOH.

11. A method as set forth in claim 1, wherein the acid added in step j) is H₃PO₄.

12. A gelatin obtainable by the method as set forth in claim 1.

13. A method as set forth in claim 2, wherein floccules are gently separated in step g) in a continuous high-speed separator.

14. A method as set forth in claim 2, wherein floccules are gently separated in step g) in a two-phase separator

15. A method as set forth in claim 2, wherein floccules are gently separated in step g) in a hermetic separator.

16. A method as set forth in claim 2, wherein the filter in step h) is a pressure filter using a filter aid containing, inter alia, kieselguhr.

17. A method as set forth in claim 2, further comprising the steps of
k) concentrating and desalting the solution, preferably with an ultrafilter,
l) filtering the concentrated solution through a polishing filter, preferably a sheet filter, and
m) concentrating, sterilising and drying the solution according to conventional techniques to a commercially dry gelatin.

18. A method as set forth in claim 2, wherein in step f) the pH is adjusted to 6.5.

19. A method of set forth in claim 2, wherein in step j) the acid is added to a pH of 4.9.

20. A method as set forth in claim 2, wherein the pH in step f) is adjusted by NaOH.
